(19) United States
(12) Patent Application Publication
(10) Pub. No.: US 2007/0192203 A1
(43) Pub. Date: Aug. 16, 2007

(54) Virtual reality shopping system

(76) Inventor: Michael Vincent Di Stefano, Martinsville, NJ (US)

Correspondence Address: Michael V. Di Stefano, 37 Hillcrest Road, Martinsville, NJ, 08836, US

(21) Appl. No.: 11/355,210

(22) Filed: Feb. 16, 2006

(51) Int. Cl. G06Q 30/00

(52) U.S. Cl. 705/26

(57) ABSTRACT

The Virtual Reality Shopping System and methods provides the means to extend to the Internet shopper the same shopping experience as being in the physical store. The system and methods of the Virtual Reality Shopping System Software builds upon commercially available software tools in the areas of multi-media and Internet shopping cart software. It uniquely combines the features of these tools and adds functions so to provide a Virtual Reality Shopping System that realistically conveys the physical store's intended atmosphere, environment, and customer's shopping experience, which uniquely brands that store.

### FIELD OF THE INVENTION

The present invention relates to virtual reality and, more particularly, to a virtual reality shopping system for Internet shoppers.

### BACKGROUND OF THE INVENTION

The Internet stores environment is flat and the shopper's navigation is highly mechanical, it consists of a plain a presentation of the product, a description and maybe a picture with a button to add it to the shopping cart. What is lost on the Internet shopping is that storeowner's branding evident in the physical store location, store theme, etc. This branding is something that the storeowner has given great attention to in order to uniquely position them as a superior shop for desirable customer experience.

Current solutions are limited to mimicking the store owner's color schemes and logos on the web site. The “shopping experience” is left to the sterile environment and format of the shopping cart software that is typically void of conveying any branding of the store.

These solutions fail to convey the look, feel, personality, and atmosphere that the store owner has created for his customers in his physical locations to their Internet stores.

It is therefore an object of the invention to transport the Internet shopper to the physical store through the Internet web browser.

It is another object of the invention to build upon the current Internet shopping cart function and feature and extend it to a virtual reality shopping cart.

It is another object of the invention to enable the store owner to extend the physical atmosphere of the store that the owner has created for his customers. When they walk through the front doors to the Internet shopper, they walk through the virtual front doors of the web store front.

It is another object of the invention to convey the similar if not the same customer experience and level of service to the Internet shopper as that which is provided to the physical customer shopping in the store owner's physical location.

It is another object of the invention to enable the store owner to convey their and the store's personality to the Internet shopper.

### SUMMARY OF THE INVENTION

The Virtual Reality Shopping System and methods provides the means to extend to the Internet shopper the same shopping experience as in the physical store. The system and its methods uniquely blends base components of data (images, video, and textual information), multi-media software, and Internet shopping cart software while adding new functionality to create the Virtual Reality Shopping Experience. The result is a unified system that realistically conveys the physical store's intended atmosphere, environment, and customer's shopping experience, which uniquely brands that store.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of a the key components of the virtual reality shopping system of the invention;

FIG. 2 is a block diagram view of a virtual reality shopping system as it integrates data and function to create the complete Virtual Reality Shopping Experience; and

FIG. 3 is a block diagram representation view of a virtual reality shopping software stack.

For purposes of clarity and brevity, like elements and components will bear the same designations and numbering throughout the FIGURES.

### DESCRIPTION OF THE PREFERRED EMBODIMENT

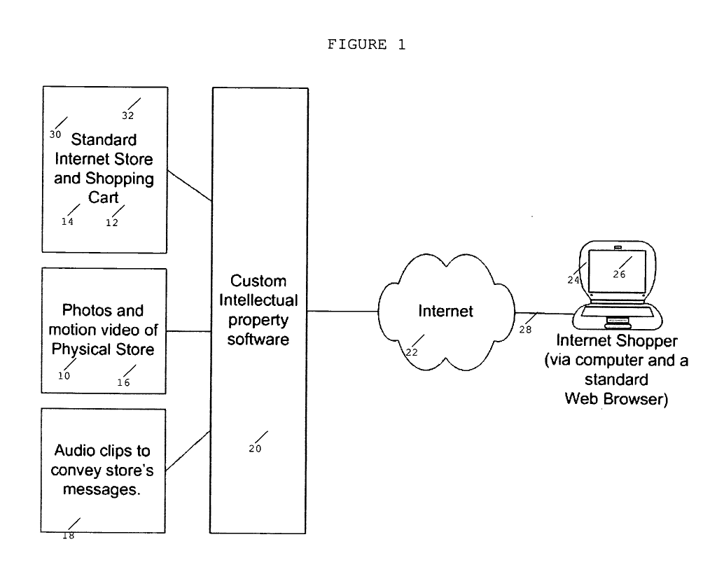

FIG. 1 is a view of the virtual reality shopping. The heart of the system is the software. Here is where all of the media and shopping cart functions are blended together to transport the shopper to the physical store, street, the complete atmosphere of the store and its surrounding areas. A user can emulate a shopper walking on the street of the store, entering the store by opening and walking through its doors, strolling up and down the isles, examining the items on the shelves, and placing them into the shopping cart. In addition the shopper can learn about the store, its owner, or via any other information the storeowner wants to use to covey his message to the shopper.

The essential component of the system infrastructure is the network (i.e. Internet) 22. This is the connectivity point of the shopper via his respective computer 24 and Internet web browser 26 and the media, shopping cart, and virtual reality shopping software 20. The media content can be large in size the number of bytes to be moved across the network or Internet 22) therefore the higher the throughput and bandwidth of both the Network or Internet 22 itself and the Internet connection 28 the better, or more complete of the Virtual Reality Shopping Experience will be.

Starting with the shopper (the person shopping), there must be a computer 24. This computer 24 can be of any vendor make, model, and operating system combination. The only constraints are that this computer 24 has a connection to the Internet that the Virtual Store is connected to. The Internet Connection 28 is any standard network connection either directly to the public Internet or through network routers, switches, or any other networking configuration that allows the computer 24 and Internet Web Browser 26 a connection to the Internet. The physical Internet Connection 28 can be of any standard networking topology of hard wired or wireless connection.

The Computer 24 Internet Browser is any standard commercially available Internet web browser 26. Examples of which are Microsoft Internet Explorer (IE), Netscape Web Browser, or Fire Fox Web Browser. A further restriction is that the web browser either natively or through a publicly available “plug in” is able to support standard Internet media formats such as jpeg and gif picture formats, flash, etc. Examples of such plug ins to a web browser are Macro Media's Flash player, Real Network Player, and Microsoft Media Player. It is through these tools of Web Browser and Media Players that the Virtual Reality Shopping Experience will be displayed to the shopper at his or her computer 24 connected to the Internet.

The media components that comprise the Virtual Reality Shopping Experience are Photos of Physical Store Location 10, Video Clip of the Store and Store Location, and Audio Clips 18. The minimum requirement to create the virtual reality store is the former, Photos of the Physical Store Location. All other media will enhance the experience creating a more complete virtual reality of the physical store.

A compete family of photos and video is essential. The more images of the physical store the better the virtual reality experience. For example, photos from various angles and every location of the store will enable the virtual reality shopping software 20 to better “recreate” the store in the shopper's computer 24 and Internet Web Browser 26.

Audio Clips 18 and Video Clips of Store and Store Location 16 include a broader scope of video information beyond that of the photo record of the physical store. It also includes people, (i.e. the store owner, employees, clerks, and customers) to provide the complete atmosphere of the store. After all, what a person experiences when physically shopping in a specific store includes all aspects of the store, its physical decoration, atmosphere as well as the quality and politeness of the store owner, clerks, and other customers. It is through this added value media to the essential photos that will completely transport the shopper to the physical store.

All of the above creates the virtual reality of the store. What is left is the merchandise the store sells, the shopping cart and checkout counter where the shopper pays and selects delivery options. These are created via Photos of merchandise to sell in the Internet store 12, textual information about the merchandise to sell in the store 32, and Audio Clips describing the merchandise to sell in the store 30. The Shopping Cart Software 14 maintains the product inventory and provides the purchasing processes.

The shopper can virtually walk through the aisles of the store, stop and examine an item. This examination process is supported by the photos, textual information, and audio clips 18 that describe the item. Depending on the completeness of the photos, the shopper can virtually touch and examine the merchandise form all angles. Should the shopper wish to purchase the item it can be placed into the shopping cart. This is where the Shopping Cart Software 14 starts to take over the process of placing potential purchases, collecting customer information, completing the purchase and order conformation. This function is standard to all Internet Shopping Cart Software 14. Examples of such software are Yahoo Merchant, and Ebay's ProStores.

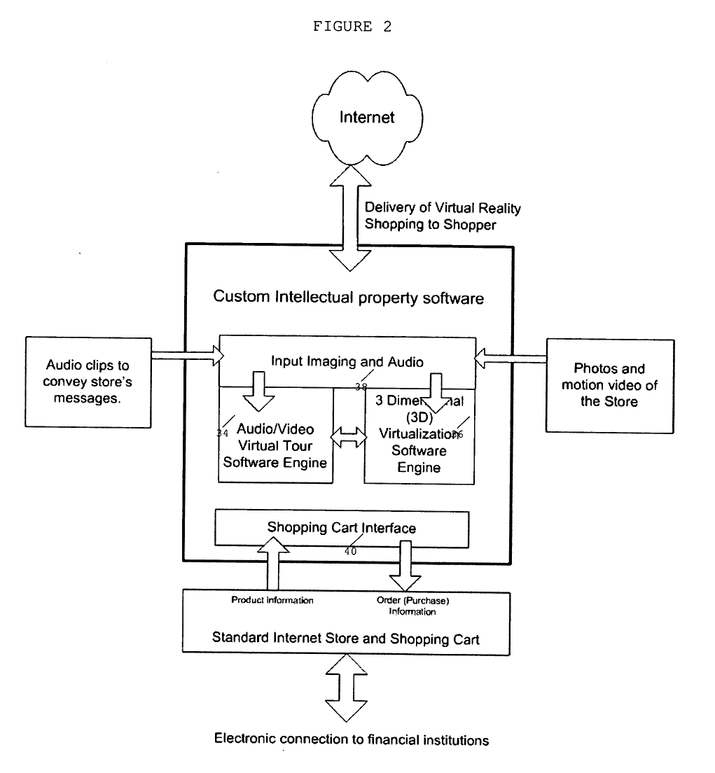

FIG. 2 is showing the five major components of the virtual reality shopping software 20. First is the virtual reality shopping software 20 itself, the Audio/Visual Virtual Tour Software 34, 3-Dimensional (3D) Virtualization Software 36, and the external system interfacing components Input Imaging and Audio Media 38 and Shopping Cart Interface 40.

The latter four components provide very specific supporting function for the Virtual Shopping Experience. The virtual reality shopping software 20 coordinates these basic components and all the necessary functions to deliver the Virtual Reality Shopping Experience.

The Audio/Visual Virtual Tour Software 34 provides a streaming of digital images (digital photographs) of a location sequenced in such a way that through the software and its navigation controls the viewer has a full spherical, navigable, and continuous 360° field-of-view. This software is commonly known as “Virtual Tour Software”. Companies such as the IPIX Corporation and Tour Vision, Inc provide commercially available Virtual Tour Software. To date, this software is most commonly used to provide Virtual Real-Estate Tours. For use in the Virtual Shopping Experience it will provide the background ambiance, the audio/visual tours of the streets and shops of the Virtual Store

These software packages commonly allow a virtual tour or movement in two dimensions, along the “X” (left and right) and “Y” (up and down) axis. This will be a minimum requirement for the Virtual Shopping Experience. Ideally, to give a complete virtual tour, movement along a third axis, the Z axis (forward and backward) will provide the shopper the sense of walking down a street or store isle. This combined with the ability for the shopper to look left and right as well as up and down will complete the sense of strolling through the virtual store and browsing the merchandise on the shelves.

The 3-Dimensional (3D) Virtualization Software 36, while not an essential component to the Virtual Reality Shopping Experience, can enhance the shoppers' experience. Some examples of commercially available 3-Dimensional (3D) Virtualization Software 36 are The Torque Game Engine (TGE), V3X, and The Reality Engine. An integration of 3-Dimensional (3D)

Virtualization Software 36 Engines with the Audio/Visual Virtual Tour Software 34 via the virtual reality shopping software 20 will add a level of shopper interaction with the virtual store that simulates a real-life interaction that shopper would have as if shopping in a brick and mortar store. The shopper can talk to a store clerk, to select and examine items off of the store's shelf, experience a taxi ride thought the streets while traveling from one virtual store front to another, etc.

These engines will need input data about the neighborhoods, streets, stores, and items. This data is in the form of digital images, motion video, audio clips 18, and plain text. The input data formats for each medium is in that respective media's of standard format (i.e., JPEG, ASCII Text, Wave file, etc.); how this data is input into the respective Audio/Visual Virtual Tour Software 34 and 3-Dimensional (3D) Virtualization Software 36 packages is specific to each package's Application Programmatic Interface (API). Therefore an essential component of the Virtual Shopping Experience is the Input Imaging and Audio Media 38 software. This is a custom software component that lowers the technical and data processing barrier to quickly and efficiently bring the complex media formats into the respective engines on an as needed basis.

The Input Imaging and Audio Media 38 software component is an optimization of interfacing with external computer 24 systems such as hard disks, file systems, and data caches with the Audio/Visual Virtual Tour Software 34 and 3-Dimensional (3D) Virtualization Software 36 packages. This data input interface is the first step in providing the shopper a “smooth”, non-interrupted virtual shopping experience. (The “smooth”, non-interrupted virtual shopping experience will be expanded upon in the following paragraphs.) One of the major characteristics of media data (regardless of the format) is that it is large in size, therefore the ability to locate the appropriate media, and transport it into either or both of the Audio/Visual Virtual Tour Software 34 and 3-Dimensional (3D) Virtualization Software 36 packages in a quick and efficient manner is a clear necessity in providing a “realistic” smooth, non-jittery Virtual Reality Shopping Experience.

The “Virtual Reality Shopping Experience” implies that shopping is involved; the act of placing items in a shopping cart and purchasing it is expected. The virtual reality shopping software 20 will leverage the function and features of commercially available Internet Shopping Cart Software 14. Examples of such software are Yahoo Merchant, and Ebay's ProStores. The interaction of Shopping Cart Software 14 and virtual reality shopping software 20 is bi-directional. Input to the virtual reality shopping software 20 from the Shopping Cart Software 14 are the items offered on the store and all the necessary data the shopper will need to make a purchase decision. This information includes but is not limited to pictures and description of the item as well as pricing and inventory information. Input to the Shopping Cart Software 14 from the virtual reality shopping software 20, will be the shopper's information to complete a purchase transaction. This information includes but is not limited to customer name, address, and credit card data.

There is an additional characteristic of this interface regarding the sensitive nature of the data and transactional nature of a purchase. Customer sensitive information is shared across this boundary, information such as customer name, address, and credit card information. This interface, when a purchase action is being taken, is transactional. Credit card information is supplied along with the shopper's address and items to be purchased. This is passed to the shopping cart that will perform the necessary steps with the bank and clearing services and gateways to complete the transaction. Once complete, the shopper is returned with a successful transaction and purchase tracking number or a rejection with the respective reason for the purchase rejection. Therefore the Shopping Cart Interface 40 Software must support the same level of data protection and transactional of the Shopping Cart Software 14.

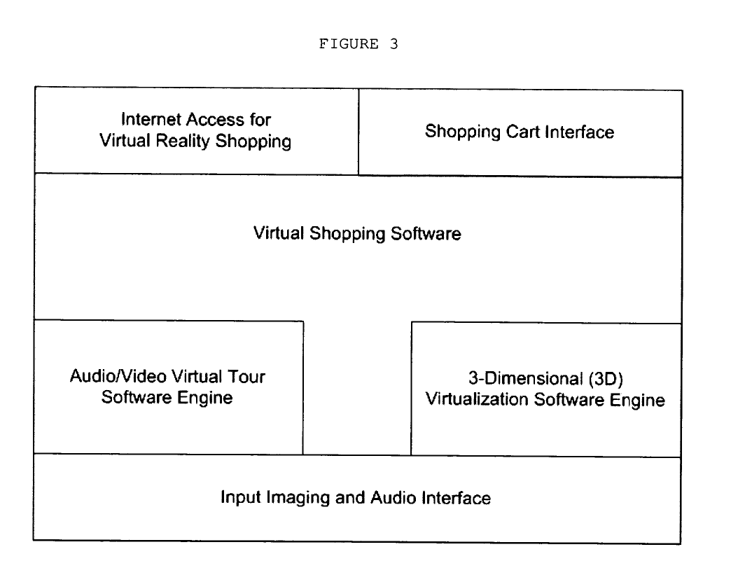

FIG. 3 shows the software stack of the components of the virtual reality shopping software 20 and will be referenced when discussing the main functions of the virtual reality shopping software 20, the main component is the heart of the Virtual Shopping Experience. This is the component that

1. Coordinates all the function and features of the other 4 components described above.

2. Adds function and feature to provide the complete Shoppers' Virtual Reality Shopping Experience.

To best understand the function and feature of this last component, we will look at consider what must be delivered to the shopper, as viewed by the shopper.

The virtual reality shopping software 20 tightly integrates the features of the Audio/Visual Virtual Tour Software 34, Shopping Cart Software 14, the variety of media data, and optionally the 3-Dimensional (3D) Virtualization Software 36 by building upon these components in such a way as to add features specific to the Virtual Reality Shopping Experience. One such example is to superpose an item from the shopping cart into the Audio/Visual Virtual Tour Software 34 so that the shopper can “see” that item on the shelf of the store. The shopper can “pick up” that item, examine it by viewing additional images and textual descriptions and pricing data, and even asking a clerk specific questions. Finally, if desired, place the item into their shopping cart.

Other examples of the features provided by the virtual reality shopping software 20 include but are not limited to the shopper's purchase or check out process. The shopper can review the items in the cart with a check out clerk; find out additional information about the store by talking to clerks or store's owner, etc.

From the shopper's prospective these are basic and natural actions when physically shopping at a brick and mortar store. However, to deliver this via a computer 24 involves a complex interaction of all the virtual reality shopping software 20 components. In FIG. 2, the shopper is delivered the Virtual Shopping Experience directly from the Virtual Shopping Software Component and not from the Shopping Cart Software 14 (which is how the shopper makes their purchasing decisions today). The user interaction commands in the Virtual Reality Shopping Experience are walk, drive, enter, leave, peruse, examine item, ask, purchase, etc. Each user action involves:

1. Interaction of workflow and data among all the virtual reality shopping software 20 components, and

2. Path Interaction Controls specific to each action that the shopper will use to navigate the path.

The virtual reality shopping software 20 implements and manages these processes.

The Virtual Reality Shopping Experience Interaction Commands fall into basic categories: Travel, Peruse, Inquire, and Transact. All interaction commands are managed via the virtual reality shopping software 20, which also is the primary interaction point for the shopper and the Virtual Reality Shopping Experience. The following are the process flow and component interactions to deliver the basic Interaction Command Categories.

Travel: The shopper can move or travel along the streets or through the store. At any point in the process flow of the Interaction Commands, the shopper will be able to transition from the current Interaction Command to another. For example a shopper can transition from Travel to Peruse to Examine to Travel to etc.

1. Identify the path to be traveled

2. Load the necessary media into the Audio/Visual Virtual Tour Software 34 and 3-Dimensional (3D) Virtualization Software 36, if available.

3. Display the path navigation controls to the shopper

4. Start the shopper down the path to travel

5. Accept Shopper Navigation Commands

6. Translate the shopper's navigation command into the appropriate command or commands to the Audio/Visual Virtual Tour Software 34 and 3-Dimensional (3D) Virtualization Software 36, if available

7. If needed load any additional media into the Audio/Visual Virtual Tour Software 34 and 3-Dimensional (3D) Virtualization Software 36, if available

8. If necessary integrate the output of the Audio/Visual Virtual Tour Software 34 and 3-Dimensional (3D) Virtualization Software 36, if available, to generate the desired effect for the shopper

9. Display the integrated effects to the shopper

10. Repeat steps 5 through 9 as the shopper continues the Travel Experience

Peruse: This is similar to Travel with the added overlays of the product inventory on the store isles for the shopper to select, and examine. At any point in the process flow of the Interaction Commands, the shopper will be able to transition from the current Interaction Command to another. For example a shopper can transition from Travel to Peruse to Examine to Travel to etc.

1. Identify the path or area of the store to travel

2. Select the items form the inventory located on the path to peruse, the inventory is maintained in the Shopping Cart Software 14

3. Overlay or superimpose the inventory items on the appropriate locations of the path

4. Display the path navigation controls to the shopper

5. Start the shopper down the path to travel

6. Accept Shopper Navigation Commands

7. Translate the shopper's navigation command into the appropriate command or commands to the Audio/Visual Virtual Tour Software 34 and 3-Dimensional (3D) Virtualization Software 36, if available

8. If needed load any additional media into the Audio/Visual Virtual Tour Software 34 and 3-Dimensional (3D) Virtualization Software 36, if available

9. If necessary integrate the output of the Audio/Visual Virtual Tour Software 34 and 3-Dimensional (3D) Virtualization Software 36, if available to generate the desired effect for the shopper

10. Display the integrated effects to the shopper

11. Repeat steps 5 through 10 as the shopper continues the Travel Experience

Inquire: involves the selection of an item and allowing the shopper to view and inquire about the item. At any point in the process flow of the Interaction Commands, the shopper will be able to transition from the current Interaction Command to another. For example a shopper can transition from Travel to Peruse to Examine to Travel to etc.

1. Shopper selects an item from the perused path to examine

2. Retrieve all the additional media on the item and load it into the Audio/Visual Virtual Tour Software 34 and 3-Dimensional (3D) Virtualization Software 36, if available.

3. Display examination controls to the shopper

4. Accept examination requests from the shopper and take the indicated actions (these can be rotate the item, view descriptions, price, talk to a clerk, etc.)

5. Translate the shopper's examination command into the appropriate command or commands to the Audio/Visual Virtual Tour Software 34 and 3-Dimensional (3D) Virtualization Software 36, if available

6. If needed load any additional media into the Audio/Visual Virtual Tour Software 34 and 3-Dimensional (3D) Virtualization Software 36, if available

7. If necessary integrate the output of the Audio/Visual Virtual Tour Software 34 and 3-Dimensional (3D) Virtualization Software 36, if available, to generate the desired effect for the shopper

8. Display the integrated effects to the shopper

9. Repeat steps 5 through 8 as the shopper continues the Travel Experience

Transact: Once the shopper has selected an item to inquire, they can decide to purchase the item. At any point in the process flow of the Interaction Commands, the shopper will be able to transition from the current Interaction Command to another. For example a shopper can transition from Travel to Peruse to Examine to Travel to etc.

1. Place the item into the shopping cart. This interaction can be done in a number of ways, dragging the item into the shopping cart, via a series of mouse clicks, or a keyboard short cut, etc.

1a. Proceed to check out. This process is identical to the check out process of the Shopping Cart Software 14 with the added Virtual Reality Shopping Experience video, audio, photo, and 3D Virtual Reality overlays to keep a consistent shopper experience. For example, the shopper can ask or further inquire about an item before continuing or finalizing a purchase.

In all the Interaction Command Categories, the virtual reality shopping software 20 manages data flow from external sources into the various components of the Virtual Reality Shopping Experience. In addition there are specific steps in each action that will require the virtual reality shopping software 20 to add feature and function not present in the supporting engines of the Audio/Visual Virtual Tour Software 34 and 3-Dimensional (3D) Virtualization Software 36. This will involve the use of standard software engineering principal to select item inventory, superimpose images in the Audio/Visual Virtual Tour and integrate the 3-Dimensional (3D) Virtualization features to deliver the best possible Interaction Command execution to the shopper. Refer to FIG. 3.

As one may expect, the Virtual Shopping Experience adds levels of complexity currently not present in Internet shopping carts of today. Complexity in data size, presentation, and simulation require unique and programming skill to deliver an effective Virtual Shopping Experience in a “smooth”, non-interrupted manner. Therefore all the components, especially the virtual reality shopping software 20 must be as efficient in data movement, interaction, and delivery as possible. A lack of efficiency in any aspect will result in a degraded, Virtual Shopping Experience thus taking away from the desired experience to the shopper.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A virtual reality shopping system for extending the look, feel, and personality of a store or service provider to the consumer of that product or service via the internet store and shopping cart. comprising:
means for standard shopping cart software that provides the electronic shopping cart, customer information collection, interactions with the financial institutions for payment collections, and interactions with shipping vendors for merchandise delivery;
means for custom software used to meld the raw media formats and shopping cart to provide the virtual shipping experience, programatically connected to said means for standard shopping cart software that provides the electronic shopping cart, customer information collection, interactions with the financial institutions for payment collections, and interactions with shipping vendors for merchandise delivery;
means for this software is combines a sequence of images to form a continuous visual flow. this software is typically commercially available and used in industries such as real-estate virtual house tours. however, for an enhanced virtual shopping experience, modifications to this software may be needed;
means for this is a software program that loads the various audio, imaging, and video media formats into the virtual tour and 3d virtualization software; and
means for this software interfaces with the standard shopping cart software with the virtual shopping experience software. here customer and product data is input from the shopping cart software into the virtual shopping experience software and customer and customer order information is input from the virtual shopping experience software to the shopping cart software.

2. The virtual reality shopping system in accordance with claim 1, wherein said means for standard shopping cart software that provides the electronic shopping cart, customer information collection, interactions with the financial institutions for payment collections, and interactions with shipping vendors for merchandise delivery comprises a shopping cart software.

3. The virtual reality shopping system in accordance with claim 1, wherein said means for custom software used to meld the raw media formats and shopping cart to provide the virtual shipping experience. comprises a virtual reality shopping software.

4. The virtual reality shopping system in accordance with claim 1, wherein said means for this software is combines a sequence of images to form a continuous visual flow. this software is typically commercially available and used in industries such as real-estate virtual house tours. however, for an enhanced virtual shopping experience, modifications to this software may be needed comprises an audio/visual virtual tour software.

5. The virtual reality shopping system in accordance with claim 1, wherein said means for this is a software program that loads the various audio, imaging, and video media formats into the virtual tour and 3d virtualization software. comprises an input imaging and audio media.

6. The virtual reality shopping system in accordance with claim 1, wherein said means for this software interfaces with the standard shopping cart software with the virtual shopping experience software. here customer and product data is input from the shopping cart software into the virtual shopping experience software and customer and customer order information is input from the virtual shopping experience software to the shopping cart software. comprises a shopping cart interface.

7. A virtual reality shopping system for extending the look, feel, and personality of a store or service provider to the consumer of that product or service via the internet store and shopping cart. comprising:
a shopping cart software, for standard shopping cart software that provides the electronic shopping cart, customer information collection, interactions with the financial institutions for payment collections, and interactions with shipping vendors for merchandise delivery;
a virtual reality shopping software, for custom software used to meld the raw media formats and shopping cart to provide the virtual shipping experience, programatically connected to said Shopping Cart Software;
an audio/visual virtual tour software, for this software is combines a sequence of images to form a continuous visual flow. this software is typically commercially available and used in industries such as real-estate virtual house tours. however, for an enhanced virtual shopping experience, modifications to this software may be needed;
an input imaging and audio media, for this is a software program that loads the various audio, imaging, and video media formats into the virtual tour and 3d virtualization software; and
a shopping cart interface, for this software interfaces with the standard shopping cart software with the virtual shopping experience software, here customer and product data is input from the shopping cart software into the virtual shopping experience software and customer and customer order information is input from the virtual shopping experience software to the shopping cart software.

8. The virtual reality shopping system as recited in claim 7, further comprising:
a 3-dimensional (3d) virtualization software, for this is standard 3 dimensional virtualization software used in computer and video gaming (i.e. sony play station, xbox, etc.). this software can increase the realism of the virtual shopping experience for the shopper by adding a close level of interaction of the shopper and the virtual store.

9. The virtual reality shopping system as recited in claim 7, wherein said shopping cart software has characteristics selected from the following group: Interaction with Bank and Payment Gateways, Interaction with shipping vendors, Collection of Customer Information needed to deliver merchandise, All other functions and features found in shopping cart software, and Collection of customer information for future marketing efforts.

10. The virtual reality shopping system as recited in claim 7, wherein said audio/visual virtual tour software has characteristics selected from the following group: Combine a sequence images to form a continuous flow, and Overlay audio on top of the combined sequence of images.

11. The virtual reality shopping system as recited in claim 7, wherein said input imaging and audio media has characteristics selected from the following group: A software path to input images into the Virtual Tour and 3D Virtualization software, A software path to input video media into the Virtual Tour and 3D Virtualization software, and A software path to input audio medi into the Virtual Tour and 3D Virtualization software.

12. The virtual reality shopping system as recited in claim 7, wherein said shopping cart interface has characteristics selected from the following group: Interface shopping cart data into the Virtual Shopping Experience Software, and Interface Customer data from the Virtual Shopping Experience Software.

13. The virtual reality shopping system as recited in claim 8, wherein said shopping cart software has characteristics selected from the following group: Interaction with Bank and Payment Gateways, Interaction with shipping vendors, Collection of Customer Information needed to deliver merchandise, All other functions and features found in shopping cart software, and Collection of customer information for future marketing efforts.

14. The virtual reality shopping system as recited in claim 8, wherein said audio/visual virtual tour software has characteristics selected from the following group: Combine a sequence images to form a continuous flow, and Overlay audio on top of the combined sequence of images.

15. The virtual reality shopping system as recited in claim 8, wherein said input imaging and audio media has characteristics selected from the following group: A software path to input images into the Virtual Tour and 3D Virtualization software, A software path to input video media into the Virtual Tour and 3D Virtualization software, and A software path to input audio medi into the Virtual Tour and 3D Virtualization software.

16. The virtual reality shopping system as recited in claim 8, wherein said shopping cart interface has characteristics selected from the following group: Interface shopping cart data into the Virtual Shopping Experience Software, and Interface Customer data from the Virtual Shopping Experience Software.

17. A virtual reality shopping system for extending the look, feel, and personality of a store or service provider to the consumer of that product or service via the internet store and shopping cart, comprising:
an Interaction with Bank and Payment Gateways, Interaction with shipping vendors, Collection of Customer Information needed to deliver merchandise, All other functions and features found in shopping cart software, Collection of customer information for future marketing efforts shopping cart software, for standard shopping cart software that provides the electronic shopping cart, customer information collection, interactions with the financial institutions for payment collections, and interactions with shipping vendors for merchandise delivery;
a virtual reality shopping software, for custom software used to meld the raw media formats and shopping cart to provide the virtual shipping experience, programatically connected to said Shopping Cart Software;
a Combine a sequence images to form a continuous flow, Overlay audio on top of the combined sequence of images audio/visual virtual tour software, for this software is combines a sequence of images to form a continuous visual flow. this software is typically commercially available and used in industries such as real-estate virtual house tours, however, for an enhanced virtual shopping experience, modifications to this software may be needed;
a 3-dimensional (3d) virtualization software, for this is standard 3 dimensional virtualization software used in computer and video gaming (i.e. sony play station, xbox, etc.). this software can increase the realism of the virtual shopping experience for the shopper by adding a close level of interaction of the shopper and the virtual store;
an A software path to input images into the Virtual Tour and 3D Virtualization software, A software path to input video media into the Virtual Tour and 3D Virtualization software, A software path to input audio medi into the Virtual Tour and 3D Virtualization software input imaging and audio media, for this is a software program that loads the various audio, imaging, and video media formats into the virtual tour and 3d virtualization software; and
an Interface shopping cart data into the Virtual Shopping Experience Software, Interface Customer data from the Virtual Shopping Experience Software shopping cart interface, for this software interfaces with the standard shopping cart software with the virtual shopping experience software. here customer and product data is input from the shopping cart software into the virtual shopping experience software and customer and customer order information is input from the virtual shopping experience software to the shopping cart software.
